(19) United States
(12) Patent Application Publication
(10) Pub. No.: US 2008/0171211 A1
(43) Pub. Date: Jul. 17, 2008

(54) Method For Protecting A Metal Surface By Means Of A Corrosion-Inhibiting Coating

(75) Inventors: Waldfried Plieth, Dresden (DE); Ursula Rammelt, Dresden (DE); Nils Hebestreit, Dresden (DE); Martin Stratmann, Meerbusch (DE); Michael Hwerder, Dusseldorf (DE); Hans-Jurgen Adler, Pirna (DE); Karin Potje-Kamloth, Dresden (DE); Evelin Jahne, Ottendorf-Okrilla (DE); Andrij Pich, Dresden (DE); Heribert Domes, Weilmunster (DE); Julia Schneider, Marburg (DE); Grazyna Paliwoda-Probeska, Duisburg (DE)

Correspondence Address: FULBRIGHT & JAWORSKI, LLP, 666 FIFTH AVE, NEW YORK, NY, 10103-3198, US

(73) Assignee: CHEMETALL GMBH, Frankfurt am Main (DE)

(21) Appl. No.: 11/659,156

(22) PCT Filed: Aug. 1, 2005
(86) PCT No.: PCT/EP05/08306

§ 371 Date: Sep. 19, 2007

(30) Foreign Application Priority Data
Aug. 3, 2004 (DE) 10 2004 037 542.9
Aug. 3, 2004 (DE) 10 2004 037 552.6
Jun. 30, 2005 (DE) 10 2005 030 488.5
Jun. 30, 2005 (DE) 10 2005 030 489.3

(51) Int. Cl. B05D 3/00; B32B 27/06; H01B 1/12

(52) U.S. Cl. 428/457; 252/500; 427/379; 427/388.1

(57) ABSTRACT

The invention relates to a method for protecting a metal surface by means of a coating based on a corrosion-inhibiting composition containing the following component(s): a) at least one type of deposit substance comprising (1) anions incorporated by an oxidation reaction and (2) releasing at least a part of said anions for a potential variation between a redox potential of the deposit substance and an undisturbed corrosion potential of a metal surface or when a comparably small potential variation is produced on a defect, wherein said anions can inhibit a partial anodic or/and cathodic corrosion reaction or/and act as an adherence initiator, said anions comprise, respectively, an ionic radius non-impairing the migration thereof, possibly b) at least one type of matrix substance, wherein said deposit substance(s) disposed in the undisturbed areas of the coating are at least partially oxidised or at least partially doped by the anions and at least one type of the deposit substance in the disturbed areas of the at least partially reduced coating or devoid at least partially of doping anions, the coating is adjusted by selecting the contained components and the contents thereof in such a way that it is possible to act at least partially and prematurely against the generation or the progression of a delamination before an intense delamination occurred. The variants of the deposit substance optionally have a relatively low cation transport rate.

The invention relates to a method for protecting a metal surface by means of a coating of a corrosion-inhibiting composition which is applied to a metal surface, is then optionally dried and is optionally also cured. This composition contains at least one depot substance, for example an electrically conductive polymer, which, in the case of a change in potential, releases anions which inhibit the anodic or/and cathodic partial reaction of corrosion or/and releases adhesion-promoting anions, so that the formation or progression of delamination is counteracted at least partly early or in good time, before pronounced delamination occurs. Such a coating can often fulfil the criteria of an intelligent coating, because it reacts only when necessary.

For a few decades, research has been carried out into conductive polymers and their use also in corrosion protection. The electrochemical phenomena on a microchemical scale are difficult to comprehend and understand. Also, because there are only a small number of measuring possibilities, which in addition are used only very rarely, the phenomena and theories are tested only very rarely. A number of phenomena and theories have been described which did not stand up to verification and are being checked to this day; see the overview article of G. M. Spinks et al. in J. Solid State Electrochem. 2002, 6, 85-100. In industrial practice, it has hitherto been possible to use conductive polymers only rarely.

EP-A1-1382721 protects methods for inhibiting the corrosion of metal surfaces, in which there are used depot substances based on polyanilines together with derivatives of mono- and dithiol-organic acids, which are incorporated as anions. Although a galvanic coupling between the defect and the coating is postulated as the release mechanism, only a reduction of oxygen and an associated rise in the pH are described, which lead to deprotonation and to release of the anions. There is no mention or indication of a release of anions as a result of a potential drop in the polymer. The inhibiting anion is always an anion of an acid. Unlike in the present application, the inhibiting anion is released only via a protonation reaction (e.g. an emeraldine salt decomposes into an emeraldine base and a Brönstedt acid, which contains the anion) and not via a redox reaction.

In Corrosion Science Section, 58, June 2002, 490-497, P. J. Kinlen et al. teach a similar method to that of EP-A1-1382721.

U.S. Pat. No. B1 6,328,874 describes methods for protecting an aluminium surface with electrochemical polymerisation and deposition of conductive polymer at very strongly anodic potentials, e.g. at from 15 to 60 V. However, it is not possible for an anion to be released by reduction from the film that is produced, because the multifunctional polymeric organic anions used are too large.

In Journal of the Electrochemical Society 147, 2000, 3667-3672, J. He et al. teach as the corrosion-inhibiting mechanism with conductive polymer the stabilisation and improvement of a naturally present passivating layer on stainless steel by anodic polarisation with galvanic contact with the conductive polymer and maintain that a more stable, more passive oxide layer is thereby obtained. The anions play no part here.

DE-A1-43 34 628 C2 discloses a method of passivating structural steel by means of conductive polymer, in particular polyaniline, which is applied in the form of a dispersion to the metal substrate. In a second process step, the coated substrate is immersed in oxygen-containing water and thereby passivated. Coating and passivation take place in separate steps. Anions are not mentioned in connection with the conductive polymer.

Many publications relating to conductive polymers do not mention anions. Most of the publications that do mention anions do not discuss corrosion-inhibiting anions. With conductive polymers, it is necessary to distinguish whether they are polymerised chemically or electrochemically, because in electrochemical polymerisation the comparatively base metal surface is always passivated prior to the deposition of the polymer: For example, the metal surface is first passivated when oxalate salts are used. At the same time, the oxalate anion is incorporated into the conductive polymer and deposited on the passivated surface. The conductive polymer so formed accordingly contains corrosion-inhibiting anions, but the publications that describe corrosion-inhibiting anions never mention the release of those anions owing to a potential drop.

It has now been demonstrated that the protective effect of the conductive polymer is present for only a short time if a corrosion-inhibiting anion has not been added to the composition containing conductive polymer because, by continual destruction of the resulting passivating layer, for example by chloride ions, the conductive polymer is reduced still further in the subsequent repassivation and is thereby consumed, because the passivation currents necessary for repassivation are very high. In the presence of corrosion-inhibiting anions, however, the passivation currents are greatly reduced.

Only chromium(VI)-containing coatings are known to have more than a self-repairing effect: 1. passivation of the metal surface at the defect or even in the damaged area (anodic partial reaction), 2. inhibition of the cathodic partial reaction (oxygen reduction) in the region that is in the process of delamination and in the already delaminated region. However, hexavalent chromate is known to be so harmful that the amount of chromate used for protecting metal surfaces is being drastically reduced for reasons of environmental protection. But even chromate is only able to passivate and repair small defects and not defects having a large surface area. No chemical system has hitherto been known, however, that actually exhibits more than such a self-repairing effect in the absence of hexavalent chromate.

Patent applications DE 102004037552 and the foreign applications following therefrom, DE 102004037542 as well as the parallel applications filed at the same patent office by the same applicant under the titles “Method for coating fine particles with conductive polymers” and “Method for coating metal surfaces with an anticorrosive coating” and the foreign applications thereof, are incorporated by reference into this application, in particular in respect of the types of depot substances, the anions, the cations, the matrix substances, the starting, intermediate and end substances, the further components that are added or that form, the starting, intermediate and end compositions, the chemical reactions, the preparation processes and conditions, the physicochemical phenomena, the properties, the definitions—in so far as they are identical with those in this patent application, the uses, the subject matters of the claims, the figures, the tables and the implementation variants.

The object was, therefore, to propose a method for protecting a metal surface by means of a corrosion-inhibiting composition, which method, for example based on conductive polymers, generally describes the measures for optimising an anticorrosive coating by means of the results of tests carried out in the laboratory.

In addition, it would be particularly advantageous if some of the chemical systems containing conductive polymers that otherwise prove advantageous would actually manifest themselves in coatings on metal substrates, in case of damage to the coating, not only by a change in potential with a gradient of the electrical field and the release of anions associated with the potential drop (release effect), but also exhibited a repair effect. However, the repair effect, in which a delaminated area is repaired again, can be hoped for only with a small number of chemical systems, namely those which fulfil the necessary conditions.

It has now been found, surprisingly, that a defect in the region of the metal/coating interface causes a potential drop, which can be utilised to effect the targeted release of, for example, corrosion-inhibiting anions from the depot substance and to counteract the damaging effects at an early stage. In contrast to the publications known to the applicants, a change in the pH value is not used here as the signal for triggering the release of the anions. When the change in pH value is used, there is no reduction of the depot substance, but only protonation or/and deprotonation. This change in pH value is used substantially only with polyanilines. With a potential drop, on the other hand, reduction of the depot substance always takes place, whereupon and whereby the anions are released.

The applicants know of no aniline, polyaniline or derivative thereof that has the action according to the invention.

The object is achieved by a method for protecting a metal surface by means of a coating of a corrosion-inhibiting composition which, after application, is optionally dried and optionally also cured, which method is characterised in that there is applied to the metal surface a coating which contains as component(s), optionally at least partly in a matrix,
a) at least one depot substance, such as, for example, at least one conductive polymer, which 1. contains at least one type of anions incorporated via an oxidation reaction as doping ions and 2. releases at least some of those anions in the case of a potential drop (reduction),
   wherein at least one type of anions is suitable for inhibiting an anodic or/and cathodic partial reaction of corrosion and optionally also for having an adhesion-promoting action, the anions in each case having an ionic radius which does not or does not substantially impair their migration through the depot substance(s) and optionally through at least one further component, for example in a matrix, of the coating,
   wherein at least one type of anions is/has been selected on the basis that these anions are mobile in water, in at least one other polar solvent or/and in a mixture also containing at least one non-polar solvent,
   wherein the release of anions from at least one depot substance takes place not, or/and only subordinately, via a deprotonation reaction but predominantly or/and wholly via a reduction reaction, and
   wherein at least one starting material for the preparation of the depot substance(s) is/has been selected on the basis that its oxidation potential is less than or equal to the decomposition potential of water or/and of at least one other polar solvent in the mixture used therefor, and
b) optionally at least one further component or/and at least one matrix substance which serves at least partly as the matrix for at least one depot substance, such as, for example, at least one organic polymer/copolymer, wherein the at least one depot substance is present in the undisturbed regions of the coating in partially oxidised form or in a form at least partly doped with anions, and wherein in the disturbed regions of the coating at least one depot substance is reduced at least partly or is freed at least partly of the doping anions,

wherein the coating is/has been so adjusted by the choice of the components it contains and the contents thereof that a substantial proportion of anticorrosive anions and optionally also of adhesion-promoting anions is released from at least one depot substance in the case of a potential drop between the redox potential of at least one depot substance in the undisturbed state and the corrosion potential of the metal surface at a defect, such as, for example, at a scratch or at an impurity at the metal/coating interface, so that the formation or/and progression of delamination is counteracted at least partly early or in good time, before pronounced delamination occurs at the metal/coating interface.

The object is additionally achieved by a method for protecting a metal surface by means of a coating of a corrosion-inhibiting composition which, after application, is optionally dried and optionally also cured, which method is characterised in that there is applied to the metal surface a coating which contains as component(s), optionally at least partly in a matrix,
a) at least one depot substance, such as, for example, at least one conductive polymer, which 1. contains at least one type of anions incorporated via an oxidation reaction as doping ions and 2. releases at least some of those anions in the case of a potential drop (reduction),
   wherein at least one type of anions is suitable for inhibiting an anodic or/and cathodic partial reaction of corrosion and optionally also for having an adhesion-promoting action, the anions in each case having an ionic radius which does not or does not substantially impair their migration through the depot substance(s) and optionally through at least one further component, for example in a matrix, of the coating,
   wherein at least one type of anions is/has been selected on the basis that these anions are mobile in water, in at least one other polar solvent or/and in a mixture also containing at least one non-polar solvent,
   wherein the release of anions from at least one depot substance takes place not, or/and only subordinately, via a deprotonation reaction but predominantly or/and wholly via a reduction reaction, and
   wherein at least one starting material for the preparation of the depot substance(s) is/has been selected on the basis that its oxidation potential is less than or equal to the decomposition potential of water or/and of at least one other polar solvent in the mixture used therefor, and
b) optionally at least one further component or/and at least one matrix substance which serves at least partly as the matrix for at least one depot substance, such as, for example, at least one organic polymer/copolymer, wherein the at least one depot substance is present in the undisturbed regions of the coating in at least partially oxidised form or in a form at least partly doped with anions, and wherein in the disturbed regions of the coating at least one depot substance is reduced at least partly or is freed at least partly of the doping anions,

wherein the coating is/has been so adjusted by the choice of the components it contains and the contents thereof that a substantial proportion of anticorrosive anions and optionally also of adhesion-promoting anions is released from at least one depot substance even in the case of a smaller potential drop than the potential drop between the redox potential of that depot substance in the undisturbed state and the corrosion potential of the metal surface at a defect, such as, for example, at a scratch or at an impurity at the metal/coating interface, in particular in the case of a smaller potential drop at a leading face of the separation, so that the formation or progression of delamination is counteracted at least partly early or in good time, before slight or pronounced delamination occurs at the metal/coating interface.

If adhesion-promoting anions occur, they do not, or do not all, also have to be anticorrosive, so that in some embodiments at least one type of adhesion-promoting anions occurs in addition to at least one type of anticorrosive anions.

The term doping within the scope of this application relates to the oxidative loading of the depot substance with anions. The term defect within the scope of this application is chosen broader than is usual with other authors, because it includes not only mechanical damage, such as, for example, scratches, but also chemical impurities, such as, for example, salt residues that have not been removed at the metal/coating interface or in the vicinity thereof. The term “delamination” within the scope of this application refers also to the edge regions of a separated area which are not yet fully separated but whose separation is just beginning, that is to say, also the mostly broadly appearing region around the defect to the leading front (“disturbed region”; outside: slight delamination). The term “disturbed region” means the region around the defect, which contains, as the case may be, both the defect, the damaged area, and also advance fronts of the change in potential, that is to say, in which changes in the chemical system have taken place. Outside the disturbed region are the undisturbed regions. The “damaged area” denotes the defect including any delamination that has occurred. Slight delamination occurs in the region of the advance cathodic front, in which the polymer adhesion is not yet destroyed, but oxygen reduction often also takes place at the interface. Pronounced delamination occurs when sufficient radicals additionally form there to destroy the adhesion at the interface. The “metal/coating interface” within the scope of this application includes all interfaces lying in the region of the metal surface and the coating according to the invention containing depot substance, that is to say, for example, also pretreatment layers or/and oxide-containing layers, which in some cases are applied unintentionally or in an uncontrolled manner, and their interfaces with adjacent coatings or metal material.

If the oxidation potential of the starting material is less than or equal to the decomposition potential of water or/and of at least one other polar solvent in the mixture used therefor, the oxidation (=polymerisation) of the conductive polymer is complete before decomposition, for example of water, and, for example, hydrogen release can occur.

It has now been demonstrated that molybdate anions, inter alia, have been released owing to a potential drop in the conductive polymer present in the disturbed region and have migrated directly to the defect. Other migration paths can be excluded in this experimental procedure. A molybdate-containing passivating layer was then formed on the metal surface at the damaged area and was determined by XPS measurements (X-ray spectroscopy).

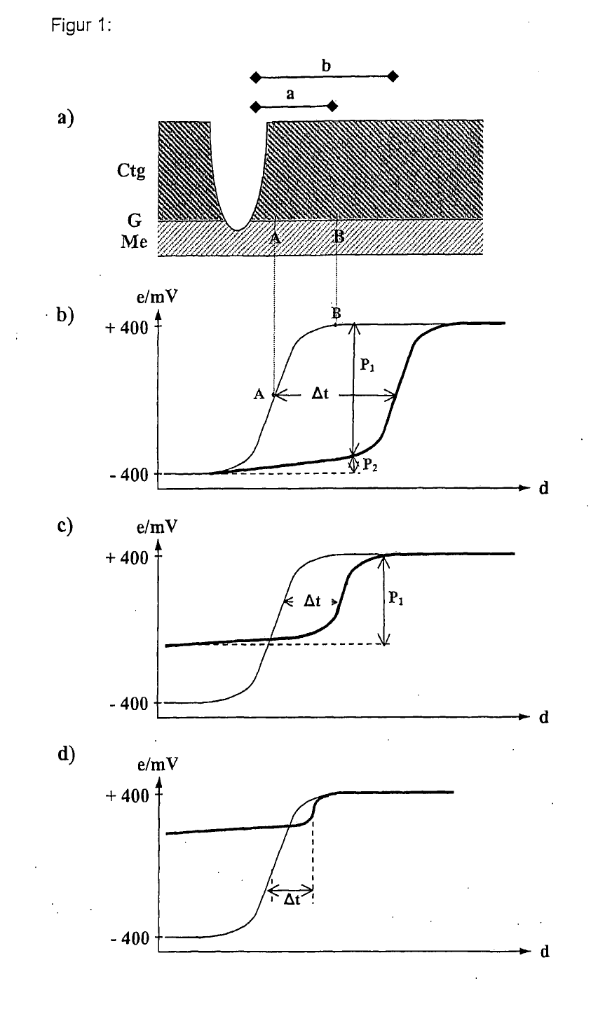

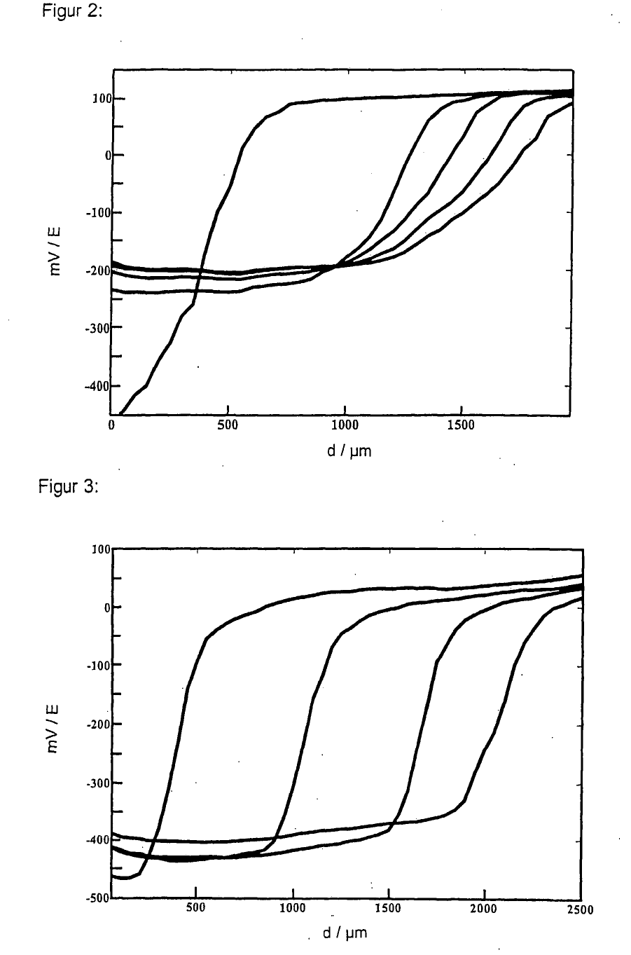

Furthermore, using a Scanning Kelvin Probe (SKP), a repair effect has now been demonstrated, in which FIG. 2 of DE 102004037542, in conjunction with the Example 1 measurement results therein, reproduces a pronounced passivating effect of a damaged region. In FIG. 2, however, all measurement curves were omitted that were obtained between the first measurement, at a very low corrosion potential, and individual measurement curves from the middle of the serial measurement. In between there is a very pronounced potential increase by about 0.3 V, which suggests that the delamination at a delaminating area has been at least partly stopped. In comparison, FIG. 1 shows the effects that generally occur.

This potential drop is preferably at least 40 mV or at least 80 mV lower than the potential drop from the redox potential of the depot substance in the undisturbed state to the corrosion potential of the metal surface at a defect, particularly preferably at least 120 mV or at least 160 mV lower, very particularly preferably at least 200 mV or at least 240 mV lower, especially at least 280 mV or at least 320 mV lower.

When selecting the starting material(s) or depot substance(s), preferably at least one starting material for the preparation of the depot substance(s) is chosen on the basis that 1. it can be or could be or has been polymerised in water, in at least one other polar solvent or/and in a mixture also containing at least one non-polar solvent, particularly preferably in water or in a mixture containing water and at least a second solvent.

The amount of anticorrosive anions released is significant when so many anticorrosive anions are released that an anticorrosive action occurs at least partly. An at least low content of water or/and of at least one other polar solvent in the starting material mixture or product mixture or in the solvent mixture of the starting material mixture or product mixture is particularly preferred, inter alia in order to bring the anions into solution or in principle to permit or facilitate their migration. The solvent mixture containing water or/and at least one other polar solvent can optionally also be an emulsion or/and a suspension. Because water or/and at least one other polar solvent is used, the oxidation potential of the starting material that comes into contact with water should where possible not be higher than the decomposition potential of water or/and at least one other polar solvent. Curing of the coating can take place by methods known per se, in particular by thermal or/and free-radical crosslinking. Alternatively or additionally, film formation can also be chosen, in particular when at least one organic polymer that can be made into a film and optionally also at least one film-forming aid is present. The matrix can be, but does not have to be, more strongly pronounced or/and delimited by at least one depot substance. In addition, at least one further component can also be present, which component can be embedded in the matrix or/and can belong to the matrix, for example in each case at least one curing agent, a type of inorganic particles, a silane/siloxane, a polysiloxane, a corrosion inhibitor, a crosslinker or/and an additive. In general, however, at least one further component can be mixed at least with the at least one depot substance.

In an embodiment, the coating according to the invention can form at least partly a matrix, such as, for example, in the case of an intercalation structure. In a further embodiment, the coating according to the invention can consist largely, substantially or wholly of at least one depot substance and optionally at least one further component; this coating is frequently a more or less uniform or substantially uniform coating, which is largely or wholly without a matrix. In a third embodiment, there can be mixed forms or/and fluid transitions between the first and second embodiment of the coating according to the invention, it also being possible for a gradient coating to be present or an almost separate first coating on the metal surface, which consists predominantly, largely or substantially of at least one depot substance, and a second coating which consists predominantly, largely or substantially of at least one further component, it being possible for the second coating optionally also to contain at least one depot substance. It can also be a coating according to the invention that consists only or substantially only of at least one depot substance. Small contents in particular of at least one of the substances mentioned in this application or/and at least one reaction product can optionally occur here. It is optionally possible for at least one further coating, in particular at least one organic coating, such as, for example, a primer or a multi-layer lacquer system or an adhesive layer, to be applied to this coating according to the invention. In many variants, before the composition according to the invention containing depot substance is applied, at least one pretreatment layer is applied to the cleaned or clean metal surface before a coating containing depot substance is applied, for example in order to avoid flash rust, e.g. on steel surfaces, to increase the corrosion protection or/and to improve adhesion to the subsequent coating. The types of pretreatment layers or of the subsequent coatings advantageously to be applied to the coating according to the invention, processes for their production and their properties are known in principle.

The composition according to the invention is preferably a solution, an emulsion or/and a suspension. It preferably contains, at least at the time of polymerisation, an at least small amount of water or/and of at least one other polar solvent, optionally in a solvent mixture also with at least one further non-polar solvent. The composition also optionally contains at least one organic solvent. In particular, the composition optionally contains at least 2 or at least 5 wt. % water or/and at least 2 or at least 5 wt. % of a polar solvent other than water, optionally in a solvent mixture, in a suspension or/and in an emulsion.

At least one depot substance, as a component of the composition or of the coating, is preferably already largely or completely polymerised after application of the coating. At least one depot substance is preferably largely, almost completely or completely polymerised in water or in a mixture containing water, it optionally being possible for the water also to be present in a solvent mixture, in a suspension or/and in an emulsion. The processes for preparing depot substances are known in principle. At least one depot substance based on at least one conductive polymer that is able to incorporate anions by oxidation is advantageously added to the composition. In many embodiments it is preferred that no conductive polymer, or only a small proportion of the conductive polymers used, be prepared or used into which—such as, for example, frequently on the basis of polyaniline—anions are incorporated via a protonation reaction (e.g. emeraldine base and Brönstedt acid, which contains the anion, form emeraldine salt), but only or predominantly conductive polymer into which anions are incorporated via an oxidation reaction.

The at least one matrix substance can—but does not have to—form a matrix at least in part of the coating, which matrix optionally contains at least one further component. The at least one matrix substance can be in particular at least one organic or/and inorganic substance, such as, for example, a film-forming constituent, for example organic binders or/and inorganic binders, such as, for example, based on synthetic resins, natural resins, SiO₂, water glass variants, inorganic silicates, organic silicates, such as, for example, alkyl silicates, silanes, siloxanes, polysiloxanes, silylated polymers, plasticisers, such as, for example, based on phthalates, reactive diluents, such as, for example, based on styrene or/and caprolactam, crosslinkable—so-called “drying”—oils, polysaccharides or/and mixtures thereof It is additionally possible optionally to add to the mixture also at least one surfactant.

In the method according to the invention, at least one starting material for the preparation of at least one depot substance is preferably selected from monomers or/and oligomers of aromatic compounds or/and unsaturated hydrocarbon compounds, such as, for example, alkynes, heterocyclic compounds, carbocyclic compounds, derivatives or/and combinations thereof, in particular from heterocyclic compounds wherein X═N or/and S, which are suitable for forming therefrom electrically conductive oligomer/polymer/copolymer/block copolymer/graft copolymer—all referred to here together as depot substance or as conductive polymer.

The at least one starting material can in particular be selected from unsubstituted or/and substituted compounds based on imidazole, naphthalene, phenanthrene, pyrrole, thiophene or/and thiophenol. Among the unsubstituted starting materials, pyrrole is particularly preferred. At least one starting material is optionally also prepared separately beforehand or/and in rare cases added to the composition. Usually, however, at least one depot substance is added to the composition.

Among the substituted starting materials, particular preference is given to at least one compound selected from benzimidazoles, 2-alkylthiophenols, 2-alkoxythiophenols, 2,5-dialkylthiophenols, 2,5-dialkoxythiophenols, 1-alkylpyrroles especially having from 1 to 16 carbon atoms, 1-alkoxypyrroles especially having from 1 to 16 carbon atoms, 3-alkylpyrroles especially having from 1 to 16 carbon atoms, 3-alkoxypyrroles especially having from 1 to 16 carbon atoms, 3,4-dialkylpyrroles especially having from 1 to 16 carbon atoms, 3,4-dialkoxypyrroles especially having from 1 to 16 carbon atoms, 1,3,4-trialkylpyrroles especially having from 1 to 16 carbon atoms, 1,3,4-trialkoxypyrroles especially having from 1 to 16 carbon atoms, 1-arylpyrroles, 3-arylpyrroles, l-aryl-3-alkypyrroles especially having from 1 to 16 carbon atoms, 1-aryl-3-alkoxypyrroles especially having from 1 to 16 carbon atoms, 1-aryl-3,4-dialkylpyrroles especially having from 1 to 16 carbon atoms, 1-aryl-3,4-dialkoxypyrroles especially having from 1 to 16 carbon atoms, 3-alkylthiophenes especially having from 1 to 16 carbon atoms, 3-alkoxythiophenes especially having from 1 to 16 carbon atoms, 3,4-dialkylthiophenes especially having from 1 to 16 carbon atoms, 3,4-dialkoxythiophenes especially having from 1 to 16 carbon atoms, 3,4-ethylenedioxythiophenes and derivatives thereof. It is here possible to select at least one compound based on pyrrol-1-ylalkylphosphonic acid especially having from 1 to 16 carbon atoms, pyrrol-1-ylalkylphosphoric acid especially having from 1 to 16 carbon atoms, pyrrol-3-ylalkylphosphonic acid especially having from 1 to 16 carbon atoms, pyrrol-3-ylalkylphosphoric acid especially having from 1 to 16 carbon atoms, 5-alkyl-3,4-ethylenedioxythiophene especially having from 1 to 12 carbon atoms, 5-(ω-phosphono)alkyl-3,4-ethylenedioxythiophene and derivatives thereof, especially having from 1 to 12 carbon atoms, which are prepared, used as the basis for the preparation of the depot substance or added to the composition. The number of carbon atoms, in each case independently of the others, can be 1, 2, 3, 4, 5, 6, 7, 8, 9, 10, 11, 12, 13, 14, 15 or/and 16.

Among the substituted starting materials, at least one compound selected from 2-methylthiophenol, 2-methoxythiophenol, 2,5-dimethylthiophenol, 2,5-dimethoxythio-phenol, 1-methylpyrrole, 1-ethylpyrrole, pyrrol-1-ylalkylphosphonic acid especially having 10 or/and 12 carbon atoms, pyrrol-1-ylalkyl phosphate especially having 12 carbon atoms, 1-methoxypyrrole, 1-ethoxypyrrole, pyrrol-3-ylalkylphosphonic acid especially having 6, 8 or/and 11 carbon atoms, 3-methoxypyrrole, 3-ethoxypyrrole, 3,4-dimethylpyrrole, 3,4-dimethoxypyrrole, 1,3,4-trimethylpyrrole, 1,3,4-trimethoxypyrrole, 1-phenylpyrrole, 3-phenylpyrrole, 1-phenyl-3-methylpyrrole, 1-phenyl-3-methoxypyrrole, 1-phenyl-3,4-dimethylpyrrole, 1-phenyl-3,4-dimethoxypyrrole, 3-methylthiophene, 3-ethylthiophene, 3-hexylthiophene, 3-octylthiophene, 3-methoxythiophene, 3-ethoxythiophene, 3-hexoxythiophene, 3-octoxythiophene, 3,4-dimethylthiophene, 3,4-dimethoxythiophene, 5-(-(ω-phosphono)methyl-3,4-dioxythiophene and derivatives thereof, is very particularly preferably prepared, used as the basis for the preparation of the depot substance or added to the composition.

In particular, at least one compound selected from ethylthiophene, ethylenedioxy-thiophene, methylthiophene, 3-ethylpyrrole, 3-methylpyrrole, N-ethylpyrrole, N-methyl-pyrrole, 3-phenylpyrrole and derivatives thereof is prepared, used as the basis for the preparation of the depot substance or added to the composition.

Smaller oligomers, e.g. those wherein about n=8, scarcely exhibit or do not exhibit the effects of the conductive polymers. The conductive polymers are electrically neutral in the reduced state. In the oxidation of the conductive polymers, cations form, which are correspondingly able to absorb anions. The oxidised state can be established chemically with at least one oxidising agent, electrochemically or/and photochemically. It is preferable to work only or largely only chemically. It is preferred not to carry out electropolymerisation but to effect polymerisation chemically. The conductive polymers have a salt-like structure, so that the term salts can be used in the case of anion-loaded conductive polymers.

In the method according to the invention, at least one depot substance is preferably at least one conductive polymer, in particular at least one conductive polymer based on imidazole, naphthalene, phenanthrene, pyrrole, thiophene or/and thiophenol, especially based on pyrrole or/and thiophene. The preferred conductive polymers include, for example, those based on polypyrrole (PPy), polythiophene (PTH), poly(para-phenylene) PPP) or/and poly(para-phenylenevinylene) (PPV). The depot substance is prepared beforehand, either separately or in a mixture, and then added to the composition, or/and in rare cases is added to the composition in the form of a starting material or/and reacts in the composition or/and in the coating to form the depot substance.

It is particularly preferred to prepare or/and add to the composition at least one polymer selected from compounds based on poly(1-alkylpyrrole) (P1APy) especially having from 1 to 16 carbon atoms, poly(1-alkoxypyrrole) (P1AOPy) especially having from 1 to 16 carbon atoms, poly(3-alkylpyrrole) (P3APy) especially having from 1 to 16 carbon atoms, poly(3-alkoxypyrrole) (P3AOPy) especially having from 1 to 16 carbon atoms, poly(1-arylpyrrole) (P1ArPy), poly(3-arylpyrrole) (P3ArPy), poly(3-alkylthiophene) (P3ATH) especially having from 1 to 16 carbon atoms, poly(3-alkoxythiophene) (P3ATH) especially having from 1 to 16 carbon atoms, poly(3-arylthiophene) (P3ArTH), poly(3-alkylbithiophene) especially having from 1 to 16 carbon atoms, poly(3,3′-dialkylbithiophene), poly(3,3′-dialkoxybithiophene), poly(alkylterthiophene), poly(alkoxyterthiophene), poly(3,4-ethylenedioxythiophene) (PEDOT) and poly(benzo[b]thiophene) (PBTH).

It is particularly preferred to prepare or/and add to the composition at least one polymer selected from poly(1-methylpyrrole) (P1MPy), poly(1-methoxypyrrole) (P1MOPy), poly(3-methylpyrrole) (P3MPy), poly(3-methoxypyrrole) (P3MOPy), poly(1-phenyl-pyrrole) (P1PhPy), poly(3-phenylpyrrole) (P3PhPy), poly(3-methylthiophene), poly(3-hexylthiophene) (P3HT), poly(3-methoxythiophene), poly(3-hexoxythiophene), poly(3-phenylthiophene), poly(3-methylbithiophene), poly(3-hexylbithiophene), poly(3,3′-dimethylbithiophene), poly(3,3′-dihexylbithiophene), poly(3,3′-dimethoxybithiophene), poly(3,3′-dihexoxybithiophene), poly(3-methylterthiophene), poly(3-methoxy-terthiophene), poly(5-alkyl-3,4-ethylenedioxythiophene) especially having from 1 to 12 carbon atoms, poly(isothianaphthene) (PITN), polyheterocyclopentadiene (PHCP), dioxy-3,4-heterocyclopentadiene (ADO-HCP), di- to octo-heterocyclopentadiene (OCHP), substituted or/and ladder-like poly(para-phenylene) (PPP or LPPP) and substituted or/and ladder-like poly(para-phenylenevinylene) (PPV or LPPV).

It is preferred to prepare or use compounds, in each case independently of one another, having alkyl chains having 1, 2, 3, 4, 5, 6, 7, 8, 9, 10, 11, 12, 13, 14, 15 or/and 16 carbon atoms. Among the polymers there can also be selected poly(1,3-dialkylpyrrole), poly(3,4-dialkylpyrrole), poly(3,4-dialkylthiophene), poly(1,3,4-trialkylpyrrole), poly(3,4-dialkoxythiophene), poly(1,3,4-trialkoxypyrrole), poly(2-arylthiophene), in each case independently of one another especially having from 1 to 16 carbon atoms, or corresponding starting materials. Among the aryl compounds, 1-phenyl, 3-phenyl, 1-biphenyl, 3-biphenyl, 1-(4-azobenzene) or/and 3-(4-azobenzene) compounds in particular can be selected.

There can be chosen as substituents in the case of the starting materials or/and polymers, in each case independently of one another, preferably H, OH, O, COOH, CH₂OH, OCH₃, CₙH₂ₙ₋₁, especially where n=from 2 to 12, OCₙH₂ₙ₋₁, especially where n=from 2 to 12, alkyl, alkoxy, aryl, amine, amino, amide, primary ammonium, imino, imide, halogen, carboxy, carboxylate, mercapto, phosphonate, S, sulfone or/and sulfonate.

Although the conductive polymers suitable therefor are in most cases known in principle, some of them have not yet been described as for at least one variant of corrosion protection; in cases where corrosion protection is described for this polymer, the corrosion protection is not effective in the case of more base metal surfaces unless a passivating layer is already present. In some embodiments, at least one depot substance can at least partly form a matrix in the composition, in particular close to the metal/coating interface. Most conductive polymers are not available commercially.

It is advantageous to use either a conductive polymer modified by substituents or/and by a different base molecule (monomer/oligomer) or/and a conductive polymer containing at least two different base molecules (monomers/oligomers) having slightly different redox potentials, in order markedly to vary the redox properties of the depot substance from compound to compound. Alternatively or additionally, correspondingly different depot substances can be mixed with one another. As a result, it is possible to select at least one compound that has the correct level of redox potential for the chemical system, including the metal surface. The redox potential of the depot substance is particularly suitable when it is at least 75 mV, at least 100 mV or at least 150 mV, preferably at least 200 mV or at least 250 mV, very particularly preferably at least 300 mV or at least 350 mV, above the corrosion potential of the metal surface.

A depot substance can in principle have been polymerised chemically, electrochemically or/and photochemically. Preferably, the at least one depot substance, or the composition containing it, is applied electrochemically or/and mechanically in particular to the metal surfaces. In the case of electrochemical application, the comparatively more base metal surfaces must be passivated beforehand in order to suppress the pronounced dissolution of the metal substances. In the case of electrochemical application, therefore, corrosion-inhibiting anions must always have been or be added to the solution from which at least one starting material is polymerised, in order always first to form a passivating layer. The conductive polymer formed in this manner accordingly automatically contains corrosion-inhibiting anions, but the publications that describe corrosion-inhibiting anions never mention the release of these anions owing to a potential drop.

In the method according to the invention there are preferably chosen at least one depot substance and at least one anion that allow the anions to be released largely or wholly from the depot substance, as a result of which the cation transport rate of the cations in particular from the electrolyte or/and from the defect can be markedly reduced, which in turn allows the formation of harmful radicals in the region of the metal/coating interface to be reduced.

For the preparation of the at least one depot substance there is conventionally required, in addition to at least one starting material and at least one anion that can be incorporated into the depot substance, at least one oxidising agent, in so far as an agent such as, for example, at least one added anion does not already act as oxidising agent.

There can be used as the oxidising agent, for example, at least one compound based on acids whose salts can be present in several valence stages, such as, for example, iron salts, based on peroxides or/and per-acids, such as, for example, peroxodisulfate.

The anions that can be incorporated into the depot substance(s) by oxidation can be selected in particular from those based on alkanoic acids, arenoic acids, boron-containing acids, fluorine-containing acids, heteropolyacids, isopolyacids, iodine-containing acids, silicic acids, Lewis acids, mineral acids, molybdenum-containing acids, per-acids, phosphorus-containing acids, vanadium-containing acids, tungsten-containing acids, salts thereof and mixtures thereof.

In the method according to the invention, the at least one type of anticorrosive mobile anions is preferably at least one based on benzoate, carboxylate, such as, for example, lactate, dithiol, fumarate, complex fluoride, lanthanate, metaborate, molybdate, a nitro compound, such as, for example, based on nitrosalicylate, octanoate, phosphorus-containing oxyanions, such as, for example, phosphate or/and phosphonate, phthalate, salicylate, silicate, sulfoxylate, such as, for example, formaldehyde sulfoxylate, thiol, titanate, vanadate, tungstate or/and zirconate, particularly preferably at least one anion based on titanium complex fluoride or/and zirconium complex fluoride.

In the method according to the invention, the at least one type of adhesion-promoting anions is preferably at least one based on phosphorus-containing oxyanions, such as, for example, phosphonate, silane, siloxane, polysiloxane or/and surfactant.

In the method according to the invention there is used as the at least one type of corrosion-inhibiting or/and adhesion-promoting anions preferably a mixture of at least two types of anions, particularly preferably a mixture based on at least one of the above-mentioned anticorrosive movable anions with at least one type of the above-mentioned adhesion-promoting anions, in particular selected from those based on carboxylate, complex fluoride, molybdate, nitro compound, phosphonate, polysiloxane, silane, siloxane or/and surfactant, very particularly preferably a mixture based on at least one of the above-mentioned anticorrosive mobile anions with at least one type of the above-mentioned adhesion-promoting anions. In particular, a mixture of anion types selected from anion types on the one hand based on carboxylate, complex fluoride, molybdate and nitro compound and on the other hand based on phosphorus-containing oxyanions, polysiloxane, silane, siloxane or/and surfactant is used.

In the method according to the invention, at least one type of releasable anions is preferably one that is mobile in water, in at least one other polar solvent or/and in a solvent mixture containing at least one polar solvent. It is particularly preferred for the at least one type of releasable anions to be soluble in water, in at least one other polar solvent or/and in a solvent mixture containing at least one polar solvent at least in a small amount, so that it is advantageous if water, at least one other polar solvent or/and a solvent mixture containing at least one polar solvent are present for dissolving anions. The anions do not have to be anions of an acid but can also be, for example, anions of a salt. The at least one type of releasable anions is incorporated into the conductive polymer via an oxidation reaction. When the anions are released, it is also possible for a change in pH value in the electrolyte to occur at the coating in the region of the defect, but it is not used as a signal for triggering the release of the anions. In the case of conductive polymers based on polypyrrole or polythiophene, such a change in pH value cannot be used as the triggering signal because a reduction of the conductive polymer is additionally necessary, but to the applicant's knowledge this has not hitherto been described as a triggering mechanism in the publications of the prior art together with a potential drop. Electrolytes are ions in water or in at least one polar solvent that is optionally a constituent of a solvent mixture, wherein the ions and water or/and at least one other polar solvent are preferably present, even if in small amounts.

In the method according to the invention, the corrosion-inhibiting or adhesion-promoting anions are released, in particular to a substantial degree, preferably at a potential drop of less than 700 mV, particularly preferably of less than 650 mV, very particularly preferably of less than 600 mV, especially of in each case less than 550 mV, 500 mV or 450 mV.

In the method according to the invention, the corrosion-inhibiting or adhesion-promoting anions are released, in particular to a substantial degree, preferably even at a potential drop of less than 400 mV, particularly preferably of less than 350 mV, very particularly preferably of less than 300 mV, especially of in each case less than 250 mV, 200 mV, 150 mV or 100 mV.

The potential drop is here significant if a sufficient amount of anticorrosive anions is released in the chemical system according to the invention to have an anticorrosive effect and if that anticorrosive effect occurs at least according to only one mechanism—for example in the case of the anodic or cathodic partial reaction.

In the method according to the invention, the composition in some embodiments preferably also contains at least one adhesion promoter, whereby at least one adhesion promoter optionally forms adhesive bridges between the coating and the metal surface even in areas of delamination, which bridges stop or/and reverse the delamination. The latter is a true repair effect, in which not only inhibition or stopping occur.

In the method according to the invention for protecting a metal surface by means of a corrosion-inhibiting composition, the adhesion promoter is preferably at least one substance based on compounds having at least one adhesion-promoting anchor group, in particular based on phosphonate, silane, siloxane, polysiloxane or/and surfactant. The adhesion promoter is particularly preferably at least one substance based on alkyl phosphonate or/and aryl phosphonate.

In the method according to the invention, the composition preferably also contains at least one radical acceptor, such as, for example, at least one amine, which is able to absorb free radicals which form during the oxygen reduction, as a result of which the delamination can be stopped or slowed. In a preferred variant, in the case of an organic polymeric coating, the coating according to the invention can be water-dilutable and can optionally also contain at least one water-soluble constituent, for example in order to control moisture ventilation and thereby create conditions for ion migrationiinto pore channels.

Preferably, polymers containing anionic groups are preferably added. Because the charge and the effective ion size often have an effect on the velocity of migration, it is in many cases preferred to use anions of low valence.

In the method according to the invention, the metal surface is preferably first cleaned especially thoroughly, in particular in such a manner that the metal surface is cleaned to pure metal, so that all or substantially all contaminants that are not firmly adhering and are not attached to the surface are removed. As a result, complete or virtually complete wetting with the treatment liquid or composition according to the invention can also be achieved. It is advantageous to match the composition of the cleaner to the type of contamination. The metal surface is thereby particularly adapted in order to be suitable for the application of an intermediate layer or of a coating containing depot substance. After cleaning, it is recommended to rinse particularly thoroughly and well, in particular to carry out at least two rinsing operations with water, at least one operation preferably being carried out with demineralised water. Cleaning can optionally be assisted by mechanical aids, such as brushing during cleaning, by electrolytic means or/and by ultrasound.

In the method according to the invention, an adhesion-improving intermediate layer containing OH⁻ groups is preferably applied directly to the metal surface and directly beneath the coating containing at least one depot substance, in particular by application of at least one surfactant, at least one polymer/copolymer, at least one phosphorus-containing oxyanion, such as, for example, phosphonate, or/and at least one silane/siloxane/polysiloxane.

There is then applied to the coating according to the invention at least one further coating, in particular at least one organic coating or/and at least one layer containing an adhesive, optionally at least one curable organic coating, such as, for example, a primer layer or at least one lacquer layer.

A passivating layer that under certain circumstances is improved can optionally be formed on the basis of the positive “more noble” potential of the depot substance(s) compared with the negative “more base” potential of the metal surface and is preferably an oxide layer of the metals of the metal surface, as has been described, for example, for polyanilines by Wessling. The oxide layer formed on the metal surface by galvanic contact can, however, interfere with the adhesion of the conductive polymer. In the method according to the invention, however, the aim is not to enhance the oxidic passivating layer on the whole of the metal surface—that is to say independently of the defect—because the targeted passivation according to the invention often takes place for the most part or exclusively only in the region of the defect with the released anions. However, oxidic passivation in samples acting according to the invention on application of the coating according to the invention cannot be ruled out. An enhancement of the passivating layer is generally regarded as being comparatively ineffective.

In the specific case of smaller defects, the corrosion potential at the defect in the metal surface will be at a slightly higher potential, e.g. in the case of steel often in a range from −200 to 0 mV, whereas it can be lower in the case of a large defect in the metal surface, for example in the case of steel in many cases of the order of magnitude of approximately 400 mV, that is to say, for example, in the range from −320 mV to −480 mV. The slightly higher potential can be an indication of passivation of the metal surface in particular with the anions which, with the cations released from the metal surface, form a passivating layer. In comparison therewith, the redox potential of the depot substance in the undisturbed state is, for example, of the order of magnitude of approximately +350 mV. With a potential drop of only about 100 mV, about 150 mV, about 200 mV, about 250 mV or about 300 mV, for example, anions are released from the depot substance, so that there is no more pronounced separation or only limited separation or even no separation at all at the defect and in some cases no or only limited more pronounced oxygen reduction and radical formation at the metal/coating interface and also no more pronounced oxidation or only limited oxidation of the exposed metal surface (see FIG. 1).

The partial figures of FIG. 1 describe the effects by way of example:

FIG. 1a) shows a cross-section through the metal surface having a coating, which is damaged by a deep scratch. The coating Ctg optionally containing conductive polymer lies on the metal substrate Me or on an intermediate layer not shown here, such as, for example, an adhesion-promoting pretreatment layer. The interface G between Ctg and Me has become completely or/and almost completely separated in the region a around the defect. The saddle point A indicates the frequently supposed approximate position of the separation front at the particular time of the potential measurement. From the scratch to the saddle point A of the potential curve, the interface is frequently completely or/and almost completely separated (“damaged area”). Between points A and B there can be at least one advance front, for example of oxygen reduction. The “disturbed region” extends from the defect to point B. From the minimum distance b from the defect, that is to say from point B, the interface is practically undamaged. Points A and B in most cases migrate away from the defect over time and thus enlarge the damaged area or the disturbed region, as is shown by the second curve in bold face.

Partial FIGS. 1b), 1c) and 1d) show changes in potential over time in the region from the defect to the undisturbed coating in diagrams of the potential e over the distance d.

Partial FIGS. 1b), 1c) and 1d) show the changes in potential during the delamination of a coating from an initial stage, which is the same in all cases, to a particular, slightly advanced stage in each case after a time Δt₁, at which the separation at the metal/coating interface in partial FIGS. 1b) and 1c) is already somewhat advanced.

Partial FIG. 1b) shows a change in potential at a coating without the release of anions. The potential drop here progresses further into the intact region laterally from the scratch. The potential curve obtained after time Δt₁ is substantially similar to the curve of the initial stage, wherein the corrosion potential of the defect has substantially been established in the already separated region, but a slighter or more pronounced potential increase is optionally to be observed in this region, which is then attributable to an ohmic drop, which is determined by the ion transport along the interface G which is not yet completely separated. In these cases, the potential drop PI after time Δt₁ is reduced by a potential difference P₂. The defect potential in the scratch scarcely changes.

Partial FIG. 1c) shows the change in potential in the disturbed region when a depot substance is present and when a specific amount of anions, which inhibit the anodic partial reaction of corrosion, is released. The corrosion potential here increases to a certain degree in the defect and, owing to ohmic resistance, also in the disturbed region. As a result, the potential drop P₁ in the disturbed region is reduced, and accordingly the impetus for the progression of the delamination is also reduced. Even when complete passivation in the defect does not occur, it can be sufficient to stop the progression of the delamination almost completely or substantially to reduce the rate of the progression. However, there remains a greater potential difference between the disturbed and the undisturbed region (corresponds to P₁).

Partial FIG. 1d) shows the almost ideal case with virtually complete passivation of the defect, in which the delamination is halted completely and also the potential difference between the disturbed and the undisturbed region (corresponds to P₁) is minimised. It is clear from partial FIG. 1d) that, after successful repair of the defect, the release of further anions from the depot substance is stopped, because the potential difference between the defect and the depot substance falls to a minimum. The release mechanism according to the invention is hence self-regulating in the sense that it takes place only when required and does not proceed in an uncontrolled manner and that the further anions remain in the depot substance for use in the case of further damage.

In the case of cathodic delamination, such as, for example, on iron/steel, or in the case of mixed cathodic and anodic delamination, such as, for example, on zinc/zinc alloys, the progression of the delamination is determined primarily by the oxygen reduction rate and also by the stability of the metal/coating interface and the adhesion at that interface. These types of delamination are driven by the oxygen reduction rate and the radicals that form thereby, which destroy the interfacial adhesion between the metal and the coating. Cathodic delamination is usually more rapid than anodic delamination. The cathodic front of the oxygen reduction therefore usually precedes the anodic front of the metal oxidation and spreads more rapidly and further around the defect. In the case of anodic delamination, such as, for example, frequently on aluminium/aluminium alloys, the dissolution of the metal surface (metal oxidation) takes place at the anodic delamination front, that is to say at the anodic front, for example of metal dissolution. This is coupled with the start of separation and with a potential drop. It occurs in the case of filiform corrosion in particular. In all cases, however, a potential drop takes place at the anodic or at the cathodic front.

In the method according to the invention, the leading front can be in particular a cathodic front, such as, for example, of oxygen reduction. This can be coupled with the start of separation and with a potential drop. The cathodic front frequently occurs, for example, in the case of iron, steels, zinc and zinc alloys.

The object is further achieved by a method for protecting a metal surface by means of a coating of a corrosion-inhibiting composition, in which there is applied to the metal surface a coating which, after application, is optionally dried and optionally also cured and which contains as component(s) a) at least one depot substance and optionally b) at least one further component or/and at least one matrix substance, in particular conductive polymer,
wherein at least one type of anions is/has been selected on the basis that these anions are mobile in water, in at least one other polar solvent or/and in a mixture also containing at least one non-polar solvent,
wherein at least one starting material for the preparation of the depot substance(s) is/has been selected on the basis that its oxidation potential is less than or equal to the decomposition potential of water or/and of at least one other polar solvent in the mixture used therefor,
wherein at least one type of anticorrosive and optionally also at least one type of adhesion-promoting anions in at least one depot substance 1. can be or/and has been incorporated as doping ion into the structure of the at least one depot substance, 2. can also be released from that structure again in the case of a drop in the potential of the at least one depot substance (reduction) and 3. can have an anticorrosive action where a metal surface is present,
wherein at least one depot substance has a redox potential that permits the early release of at least one type of anticorrosive anions and optionally also of at least one type of adhesion-promoting anions,
wherein the release of at least one type of anticorrosive anions and optionally also of at least one type of adhesion-promoting anions from at least one depot substance takes place not or/and only subordinately via a deprotonation reaction but predominantly or/and wholly via a reduction reaction,
wherein at least one depot substance exhibits pore sizes such that the chosen anticorrosive or/and adhesion-promoting anions to be released are not or not substantially impaired when they migrate through the at least one depot substance and optionally through at least one further component, for example in a matrix, and wherein at least one depot substance has a comparatively low cation transport rate.

The cation transport rate of the cations from the electrolyte in particular from the defect or/and from the metal surface into the at least one depot substance is preferably less than 10⁻⁸ cm²/s, particularly preferably less than 10⁻¹⁰ cm²/s, very particularly preferably less than 10⁻¹² cm²/s, especially even less than 10⁻¹⁴ cm²/s.

In many embodiments, the redox properties of the conductive polymer are preferably to be so adjusted that, even with a low drop in the potential at the interface, a sufficiently large amount of anions is released, so that anions are already active at the forwardmost front of the delamination, in order to be able to counteract further damage even before significant damage has occurred. In this manner, as early a reaction as possible to an imminent or incipient corrosive attack can take place.

If only a limited amount of the anions is released from the depot substance, an increased cation transport rate of the depot substance for cations that migrate from the region of the defect into the depot substance can occur, because many anionic docking sites in the depot substance remain for cation migration. At a higher cation transport rate of the depot substance, the delamination rate around the damaged area and, in the critical case, also far beyond that area can be greatly increased if passivation of the defect is not successful, for example because the defect is too large. If the cation transport rate of the cations from the electrolyte in particular from the defect or/and the metal surface is kept comparatively low, the chemical system is prevented from collapsing at an early stage or even from collapsing at all. It is therefore a preferred object to achieve as complete a release as possible of the anions in the disturbed region, in order to keep the cation transport rate negligibly small if possible. It is therefore preferably also an object to keep the amount of released anions and their velocity of migration in the coating as high as possible, so that the chemical system does not collapse: the higher the anion transport rate, the lower the risk of collapse of the chemical system at an increased cation transport rate. The reason is that at a higher cation transport rate, even starting from a small defect, delamination of the entire coating at the interface with the metal surface can occur. With many variants, however, not all the advantageous properties, mechanisms and aims mentioned in this application are achieved at the same time, but frequently only a limited selection thereof is achieved.

However, if adequate note is not taken of the measures described in this application, it is readily possible for increased corrosion to occur, starting from the defect, over the entire sample and can impair the sample as a whole.

In some preferred embodiments, the amount of at least one depot substance or of the at least one depot substance is preferably distributed as homogeneously as possible or is distributed substantially homogeneously in at least one matrix substance and is so chosen that a sufficiently large amount of anions is released, so that the anion transport rate in the coating to the defect is sufficient to achieve a delamination-inhibiting action but, where possible, also so that, on the other hand, the cation transport rate is also kept sufficiently low that it does not or does not substantially further the delamination.

For it had been shown that, in the case of larger defects, compact coatings of conductive polymer lead to complete separation if the too high cation transport rate for cations from the electrolyte or/and from the defect leads to complete reduction of the depot substance and, connected therewith, to an increase in the ion concentration at the interface and therefore the cathodic delamination is greatly accelerated. The depot substance can be completely reduced thereby. If the anion transport rate is high, however, a low cation transport rate in the coating is obtained. The size of the anion transport rate in the coating to the defect is dependent, via the potential gradient, also on the nature of the metal surface and its corrosion potential and adjustable. It is preferably in each case about 10⁻⁵, 10⁻⁶, 10⁻⁷, 10⁻⁸ or 10⁻⁹ cm²/s, rarely 10⁻¹⁰, 10⁻¹¹ or 10⁻¹² cm²/s.

The anion transport rate can be influenced by choosing anions that are as small as possible, which migrate well from the depot substance and are able to migrate through the coating of matrix and components, and by the presence of a sufficient number and size of the pore channels or structural pores in the depot substance, optionally in its matrix or/and optionally in the further components of the coating for the migrating anions, in order not or not substantially to impair the anion transport rate. The migration behaviour can possibly also be influenced by 1. selecting matrix substances in such a manner that, when solvent(s) or/and volatile components leave the applied and drying coating, pores or channels form, 2. selecting matrix substances which will partly and in particular largely, but not completely, form a film, so that a larger number of pores or defective areas or/and a highly porous structure are present, through which the anions are able to migrate, e.g. by adding a smaller amount of film-forming aids, such as, for example, long-chained alcohols, than would be optimal for film formation, so that incomplete plastification occurs, 3. combining harder and softer, in particular organic particles, in the matrix, so that pores or defective areas are likewise formed, 4. incorporating hydrophobic and hydrophilic constituents side by side into the coating, so that defective areas are likewise formed, or/and 5. using a constituent for controlling the water-absorbing capacity of at least one matrix substance or/and at least one component, such as, for example, a water-soluble polymer such as, for example, polyacrylic acid. A more or less loose pore or channel structures can be obtained in particular by a mixture in which only some of the polymer particles are plastified or/and in which partially plastified polymer particles are present. The addition of, for example, at least one compound based on polyacrylic acid or/and on polyvinyl alcohol can serve to increase the water-absorbing capacity and ensure a ventilation effect and larger pore spaces in the dry film. The pores or pore channels can under certain circumstances be present also or only in the nanometre range or can be also or only cavities on about the molecule scale.

The cation transport rate of the coating can be adjusted by choosing the amount of depot substance contained, and accordingly the amount of incorporated and releasable anions, in such a manner that as low a cation transport rate as possible results in the case of damage to the coating and release of the anions. The cation transport rate is then in each case about 10⁻⁸, 10⁻⁹, 10⁻¹⁰, 10⁻¹¹, 10⁻¹², 10⁻¹³ or 10⁻¹⁴ cm²/s. For a large defect, a larger amount of depot substance and accordingly of incorporated and releasable anions is required. It is expected that corrosion can be inhibited at small defects, such as, for example, scratches, while defects having a large surface area can probably not be inhibited in many cases. The size of defect that can be inhibited is also dependent on the thickness of the coating and can be estimated via the ratio of the interface as the edge of the coating to the defect area of the exposed individual defect. In the case of small defects, this ratio often has values in the range of approximately from 0.01 to 100 or 1000, while large defects with a ratio of, for example, 10,000 or more, as in the case of chromating, can no longer be inhibited.

In oxygen reduction, radicals or anions such as, for example, OH⁻, O₂⁻, etc. form, which can destroy the adhesion at the metal/coating interface: this can rapidly lead to complete separation. This risk can be counteracted 1.) by releasing anions that markedly reduce the oxygen reduction at the metal/coating interface, 2.) by effecting substantial or complete release of the anions from the depot substance, as a result of which the cation transport rate of the cations in particular from the electrolyte or/and from the defect can be kept small or can be markedly reduced, as a result of which the charge transfer necessary to maintain the cathodic partial reaction is likewise kept small, as a result of which the formation of radicals in the region of the metal/coating interface is also counteracted, 3.) by relocating the radical formation per interface unit by relocating the oxygen reduction from the metal/coating interface to the interface between two superposed coatings, or/and 4.) by incorporating on the one hand at least one radical acceptor into the coating containing the depot substance. This third process is furthered by electronically conducting depot substances, which transport the electrons necessary for the cathodic partial reaction from the metal/coating interface to the interface between the two superposed coatings.

In the method according to the invention it is also possible to make use of the fact that the oxygen reduction in at least two superposed coatings is relocated away from the metal surface owing to the electronic conductivity of the depot substance to the interface between the two coatings, so that the oxygen reduction preferably occurs at the interface or boundary layer between the two adjacent coatings and less or not at all at the interface between the metal and the first coating, so that delamination at the interface between the metal and the first coating occurs to a lesser degree or not at all.

It was, however, possible to determine all these phenomena and effects only by the use of a Scanning Kelvin Probe, which is available for such tests at the Max-Planck-Institut fur Eisenforschung in Düsseldorf. The use of a Scanning Kelvin Probe (SKP) and related devices such as SKPFM (Scanning Kelvin Probe Force Microscopy) are the only probes hitherto used, also only very rarely, which can in principle be employed for determining the potential drop in the case of delamination. To the applicant's knowledge there are only three or four devices for SKP testing in corrosion research which are currently being used for research into corrosion mechanisms, while many devices are not being used for that purpose or are not suitable therefor or are not ready for use. Therefore, virtually no information in scientific literature, apart from that of the Max-Planck-Institut für Eisenforschung in Düsseldorf, is based on such suitable tests, while other authors repeatedly make speculations in their statements.

It has been found, surprisingly, that a defect in the region of the metal/coating interface causes a potential drop which can be used to effect the targeted release of, for example, corrosion-inhibiting anions from the depot substance and to counteract the damaging effects at an early stage.

It has been found, surprisingly, that there are leading fronts which already exhibit a low potential drop and occur outside the mechanically completely separated area, so that it is possible, in a chemical coating system, to use only slight potential drops to release the corrosion-inhibiting anions which counteract the damaging effects.

It has additionally been found, surprisingly, that it is possible with suitably selected chemical systems not only to counteract and to stop advancing separation but also in some cases to repair it.

Furthermore, it has also been possible, surprisingly, to repair the disturbed regions again with an adhesion promoter, by adding releasable anions which are able to act as adhesion promoter.

It has further been found, surprisingly, that the delamination can be slowed or stopped by the addition of radical acceptors.

It has also been found, surprisingly, that, to the inventors' knowledge, several further processes that take place here have not hitherto been described among experts, such as, for example: 1.) that the potential difference starting from the defect can lead in the depot substance to the release of suitable anions which can act as corrosion inhibitors, 2.) that complete passivation of the defect is not necessary in every case in order markedly to improve the corrosion behaviour, but that a marked reduction of the anodic partial reaction of corrosion and the associated slight rise in the corrosion potential brings about a marked reduction in the delamination rate, and 3.) that, if the suitable ion transport rates are not observed, anion release does not take place but a selective cation incorporation, which does not lead to improved corrosion protection but to the immediate collapse of the chemical system.

Surprisingly, it has been possible to demonstrate the release and migration of the anions from the conductive polymer to the corroding region and the hoped for anticorrosive action of the coatings according to the invention not only in very specific tests, such as, for example, using a Scanning Kelvin Probe (SKP), but the concentration of the anticorrosive anions in the corroding region and a significant increase in the corrosion protection of metal substrates by means of an organic coating containing conductive polymer, also in the microscopic range, with practice-relevant probes and tests, such as, for example, in the salt spray test.

### EXAMPLES AND COMPARISON EXAMPLES

The following exemplary embodiments illustrate the invention by way of example in individual selected variants:

### Example 1 and Comparison Example 1

Two thoroughly cleaned iron samples were completely coated on one surface, by spin coating, with a composite film of a filmed lacquer containing polypyrrole-coated core-shell particles having a core of polypyrrole-acrylate copolymer. Then an insulating model clear lacquer film based on epoxide was applied, likewise by spin coating. In Example 1, molybdate anions MoO₄²⁻ had been incorporated into the polypyrrole (FIG. 2) and in Comparison Example 1 sulfate anions SO₄²⁻ had been incorporated (FIG. 3). Molybdate is an anion that can in principle be removed from the depot substance and that has a corrosion-inhibiting action. Sulfate is an anion that can in principle be removed from the depot substance but has neither a corrosion-inhibiting nor an adhesion-promoting action. A defect having a large surface area, which reached to the metal, was applied to both samples, in each case on the coated surface. There was then applied to this defect having a large surface area a 0.1 molar sodium chloride solution which came into contact with the coated region only at the edge of the defect. There was thus obtained a standard structure for a conventional delamination experiment in which a delamination starting from the defect, with a potential drop, advances at the filmed coating/metal interface. The incorporated conductive polymer was thereby reduced. The anions were removed at least partly and served in Example 1 to form an incomplete passivating layer based on oxide/molybdate. In Comparison Example 1, the released anions did not have corrosion-inhibiting action.

FIG. 3 (Comparison Example 1) shows the change over time in the potential from curve to curve, in each case at 2-hour intervals. The disturbed region spreads continuously. A pronounced reduction in the rate of spread with time and a marked change in the corrosion potential in the defect cannot be seen.

FIG. 2 (Example 1), on the other hand, shows the change over time in the potential from curve to curve, in each case at 2-hour intervals on release of corrosion-inhibiting anions, as already shown by way of example in FIG. 1c). The corrosion potential in the disturbed region increases greatly at first and then increases further slightly, as a result of which the potential difference between the undisturbed region and the disturbed region is markedly reduced and accordingly also the impetus for the progression of the delamination is markedly reduced. After a short time, the rate of spread of the disturbed region falls, until the rate of spread after several hours is virtually zero. Even this incomplete passivation leads to almost complete stoppage of the delamination.

With the release of a comparatively small amount of corrosion-inhibiting anions, a marked effect can already be seen, which therefore has an effect only after a relatively long time.

### Example 2 and Comparison Example 2

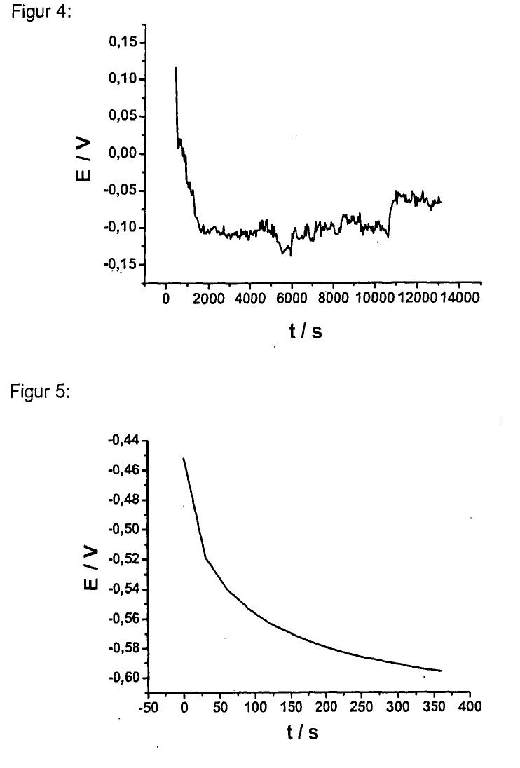

Two thoroughly cleaned iron samples were completely coated on all sides, electrochemically, with a film of pure polypyrrole, molybdate anions MoO₄²⁻ having been incorporated into the polypyrrole in Example 2 (FIG. 4) and hexafluorophosphate anions PF₆¹⁻ having been incorporated in Comparison Example 2 (FIG. 5). Molybdate is an anion that can in principle be removed from the depot substance and that has a corrosion-inhibiting action. Hexafluorophosphate is an anion that can in principle be removed from the depot substance but has neither a corrosion-inhibiting nor an adhesion-promoting action. Both samples were provided on one of their surfaces with a small scratch, which reached to the metal. The samples were then immersed in a 3% sodium chloride solution. Owing to the high exchange current densities in the defect, the electrode potential of the sample was determined from the corrosion potential of the scratch.

In Comparison Example 2, the corrosion potential in the defect fell within 100 s to the free corrosion potential of the iron, which indicates corrosion unaffected by the conductive polymer (FIG. 5). Even after 1 s, a corrosion potential of about −450 mV SCE had been reached, which is already close to the free corrosion potential of iron of about −600 mV SCE.

In Example 2, a corrosion potential of about −100 mV SCE was measured even after more than 3 hours, which is still very far from the free corrosion potential of iron of about −600 mV SCE and is characterised by pronounced oscillations, which are characteristic of a chloride attack and repassivation by the molybdate anion (FIG. 4). The corrosion potential of about −100 mV SCE is typical of passivation of the iron in a chloride solution with an oxide/molybdate layer. Unlike in Comparison Example 2, a potential of about +0.1 mV SCE is still to be seen even after several minutes, which is determined by the redox potential of the conductive polymer. In analogy to Example 1, the protective effect in Example 2 is achieved by the released molybdate anions, which are able to inhibit the corrosion in the defect. Because in Example 2, owing to the complete immersion of the sample in the corrosion solution, the ratio of the volume or surface area of active depot substance to the surface area of the defect in the scratch is more advantageous by orders of magnitude than in Example 1 (delamination in the case of a corrosive solution acting only locally in the defect and at the edge of the defect), the protective effect observed here is also more evident.

1-29. (canceled)

30. A method comprising protecting a metal surface from corrosion by applying to the metal surface a coating composition comprising
a) at least one depot substance, such as, for example, at least one conductive polymer, which i) contains at least one type of anions incorporated via an oxidation reaction as doping ions and ii) releases at least some of those anions in the case of a reduction in electric potential, wherein at least one type of anion is suitable for inhibiting an anodic or cathodic partial reaction of corrosion and optionally also for having an adhesion-promoting action, the anions in each case having an ionic radius which does not or does not substantially impair their migration through the depot substance(s) and optionally through at least one further component, for example in a matrix, of the coating,
wherein at least one type of anions is/has been selected on the basis that these anions are mobile in water, in at least one other polar solvent or in a mixture also containing at least one non-polar solvent,
wherein the release of anions from at least one depot substance takes place not or only subordinately via a deprotonation reaction but predominantly or wholly via a reduction reaction, and
wherein at least one starting material for the preparation of the depot substance(s) is/has been selected on the basis that its oxidation potential is less than or equal to the decomposition potential of water or of at least ore other polar solvent in the mixture used therefor, and
b) optionally at least one further component or at least one matrix substance which serves at least partly as the matrix for at least one depot substance, such as, for example, at least one organic polymer/copolymer, wherein the at least one depot substance is present in tie undisturbed regions of the coating in at least partially ixidized form or in a form at least partly doped with anions, and wherein in the disturbed regions of the coating at least one depot substance is reduced at least partly or is freed at least partly of the doping anions,
wherein tie coating is/has been so adjusted by the choice of the components it contains and the contents thereof that a substantial proportion of anticorrosive anions and optionally also of adhesion-promoting anions is released from at least one depot substance in the case of a potential drop between the redox potential of at least one depot substance in the undisturbed state and the corrosion potential of the metal surface at a defect, such as, for example, at a scratch or at an impurity at the metal/coating interface, so that the formation or progression of delamination is counteracted at least partly early or in good time, before pronounced delamination occurs at the metal/coating interface.

31. A method for protecting a metal surface by means of a coating of a corrosion-inhibiting composition which, after application, is optionally dried and optionally also cried, wherein there is applied to the metal surface a coating which contains as component(s), optionally at least partly in a matrix,
a) at least one depot substance, such as, for example, at least one conductive polymer, which 1. contains at least one type of anions incorporated via an oxidation reaction as doping ions and 2. releases at least some of those anions in the case of a potential drop (reduction),
wherein at least one type of anions is suitable for inhibiting an anodic or cathodic partial reaction of corrosion and optionally also for having an adhesion-promoting action, the anions in each case having an ionic radius which does not or does not substantially impair their migration through the depot substance(s) and optionally through at least one further component, for example in a matrix, of the coating,
wherein at least one type of anions is/has been selected on the basis that these anions are mobile in water, in at least one other polar solvent or in a mixture also containing at least one non-polar solvent,
wherein the release of anions from at least one depot substance takes place not or only subordinately via a deprotonation reaction but predominantly or wholly via a reduction reaction, and
wherein at least one starting material for the preparation of the depot substance(s) is/has been selected on the basis that its oxidation potential is less than or equal to the decomposition potential of water or of at least one other polar solvent in the mixture used therefor, and
b) optionally at least one further component or at least one matrix substance which serves at least partly as the matrix for at least one depot substance, such as, for example, at least one organic polymer/copolymer, wherein the at least one depot substance is present in the undisturbed regions of the coating in at least partially oxidized form or in a form at least partly doped with anions, and wherein in the disturbed regions of the coating at least one depot substance is reduced at least partly or is freed at least partly of the doping anions,
wherein the coating is/has been so adjusted by the choice of the components it contains and the contents thereof that a substantial proportion of anticorrosive anions and optionally also of adhesion-promoting anions is released from at least one depot substance even in the case of a smaller potential drop than the potential drop between the redox potential of that depot substance in the undisturbed state and the corrosion potential of the metal surface at a defect, such as, for example, at a scratch or at an impurity at the metal/coating interface, in particular in the case of a smaller potential drop at a leading front of the separation, so that the formation or progression of delamination is counteracted, at least partly early or in good time, before slight or pronounced delamination occurs at the metal/coating interface.

32. A method for protecting a metal surface by means of a coating of a corrosion-inhibiting composition, in which there is applied to the metal surface a coating which, after application, is optionally dried and optionally also cured and which contains as component(s) a) at least one depot substance and optionally b) at least one further component or at least one matrix substance, in particular conductive polymer, wherein at least one type of anions is/has been selected on the basis that these anions are mobile in water, in at least one other polar solvent or in a mixture also containing at least one non-polar solvent,
wherein at least one starting material for the preparation of the depot substance(s) is/has been selected on the basis that its oxidation potential is less than or equal to the decomposition potential of water or of at least one other polar solvent in the mixture used therefor,
wherein at least one type of anticorrosive and optionally also at least one type of adhesion-promoting anions in at least one depot substance 1. can be or has been incorporated as doping ion into the structure of the at least one depot substance, 2. can also be released from that structure again in the case of a drop in the potential of the at least one depot substance (reduction) and 3. can have an anticorrosive action where a metal surface is present,
wherein at least one depot substance has a redox potential that permits the early release of at least one type of anticorrosive anions and optionally also of at least one type of adhesion-promoting anions,
wherein the release of at least one type of anticorrosive anions and optionally also of at least one type of adhesion-promoting anions from at least one depot substance takes place not or only subordinately via a deprotonation reaction but predominantly or wholly via a reduction reaction,
wherein at least one depot substance exhibits pore sizes such that the chosen anticorrosive or adhesion-promoting anions to be released are not or not substantially impaired when they migrate through the at least one depot substance and optionally through at least one further component, for example in a matrix, and
wherein at least one depot substance has a comparatively low cation transport rate.

33. A method according to claim 30, wherein at least one starting material for the preparation of at least one depot substance is selected from monomers or oligomers of aromatic compounds or unsaturated hydrocarbon compounds, such as, for example, alkynes, heterocyclic compounds, carbocyclic compounds, derivatives thereof or combinations thereof, which are suitable for forming therefrom electrically conductive oligomer/polymer/copolymer/block copolymer/graft copolymer.

34. A method according to claim 33, wherein at, least one starting material for the preparation of at least one depot substance is selected from heterocyclic compounds wherein X═N or S.

35. A method according to claim 33, wherein at least one starting material for the preparation of at least one depot substance is selected from unsubstituted or substituted compounds based on imidazole, naphthalene, phenanthrene, pyrrole, thiophene or thiophenol.

36. A method according to claim 30, wherein at least one depot substance is at least one conductive polymer, preferably at least one conductive polymer based on polypyrrole, polythiophene, poly(para-phenylene) or poly(para-phenylenevinylene).

37. A method according to claim 30, wherein at least one depot substance is selected from compounds based on poly(1-methyl-pyrrole), poly(1-methoxypyrrole), poly(3-methylpyrrole), poly(3-methoxypyrrole), poly(1-phenyl-pyrrole), poly(3-phenylpyrrole), poly(3-methylthiophene), poly(3-hexylthiophene), poly(3-metheloxythiophene), poly(3-hexoxythiophene), poly(3-phenyl-thiophene), poly(3-methylbithiophene), poly(3-hexylbithiophene), poly(3,3′-dimethylbithiophene), poly(3,3′-dihexylbithiophene), poly(3,3′-dimethoxy-bithiophene), poly(3,3′-dihexoxybithiophene), poly(3-methyl-terthiophene), poly(3-methoxy-terthiophene), poly(5-alkyl-3,4-ethylene-dioxy-thiophene), poly(isothianaphthene), polyheterocyclopentadiene, dioxy-3,4-heterocyclopentadiene, di- to octo-heterocyclopentadiene, substituted or ladder-like poly(para-phenylene) and substituted or ladder-like poly(para-phenylenevinylene).

38. A method according to claim 30, wherein at least one type of anions is selected from anions based on alkanoic acids, arenoic acids, boron-containing acids, fluorine-containing acids, heteropolyacids, isopolyacids, iodine-containing acids, silicic acids, Lewis acids, mineral acids, molybdenum-containing acids, per-acids, phosphorus-containing acids, vanadium-containing acids, tungsten-containing acids, salts thereof and mixtures thereof.

39. A method according to claim 30, wherein at least one type of anions is selected from anions based on benzoate, carboxylate, dithiol, sulfoxylate, such as, for example, formaldehyde sulfoxylate, fumarate, complex fluoride, lanthanate, metaborate, molybdate, nitro compound, octanoate, phthalate, phosphorus-containing oxyanions, salicylate, silicate, thiol, titanate, vanadate, tungstate and zirconate, particularly preferably at least one anion based on titanium complex fluoride or zirconium complex fluoride.

40. A method according to claim 30, wherein at least one type of adhesion-promoting anions is preferably at least one based on phosphorus-containing oxyanions, polysiloxane, silane, siloxane or surfactant.

41. A method according to claim 30, wherein there is used as the at least one type of corrosion-inhibiting or adhesion-promoting anions a mixture selected from anion types on the one hand based on carboxylate, complex fluoride, molybdate and nitro compound and on the other hand based on phosphorus-containing oxyanions, polysiloxane, silane, siloxane or surfactant.

42. A method according to claim 30, wherein the composition also contains at least one ixidizing agent, in particular based on acids whose salts can be present in several valence stages, such as, for example, iron salts, based on peroxides or per-acids, such as, for example, peroxodisulfate.

43. A method according to claim 30, wherein the leading front is a cathodic front, for example of oxygen reduction, which is coupled with the start of separation and with a potential drop.

44. A method according to claim 30, wherein the leading front is an anodic front, for example of metal dissolution, which is coupled with the start of oxidation of the metal surface and with a potential drop.

45. A method according to claim 30, wherein the corrosion-inhibiting or adhesion-promoting anions are released to a substantial degree at a potential drop of less than 700 mV.

46. A method according to claim 30, wherein the corrosion-inhibiting or adhesion-promoting anions are already released to a substantial degree at a potential drop of less than 400 mV.

47. A method according to claim 30, wherein the amount of depot substance in at least one matrix substance is distributed substantially homogenously and is so selected that anions are released in a sufficiently large amount that the anion transport rate in the coating to the defect is sufficient to achieve a delamination-inhibiting action but, on the other hand, the cation transport rate is also kept sufficiently low that it does not or does not substantially further die delamination.

48. A method according to claim 30, wherein the composition also contains at least one adhesion promoter, the adhesion promoter optionally also forming in areas of delamination adhesive bridges between the coating and the metal surface which stop or reverse the delamination.

49. A method according to claim 30, wherein the composition also contains at least one radical acceptor, such as, for example, amines, which is able to absorb the free radicals that form during the oxygen reduction, as a result of which the delamination can be stopped or slowed.

50. A method according to claim 30, wherein at least one depot substance and at least one anion are selected that allow the anions to be released largely or wholly from the depot substance, as a result of which the cation transport rate in particular from the electrolyte or from the defect can be markedly lowered, as a result of which the formation of radicals in the region of the metal/coating interface is also counteracted.

51. A method according to claim 30, wherein the oxygen reduction in at least two superposed coatings is relocated away from the metal surface owing to the electronic conductivity of the depot substance to the interface or boundary layer between the two coatings, so that the oxygen reduction preferably occurs at the boundary layer between two adjacent coatings and less or not at all at the interface between the metal and the first coating and so that the delamination at the interface between the metal and the first coating occurs less or not at all.

52. A method according to claim 30, wherein an adhesion-improving intermediate layer containing OH⁻ groups is applied directly to tie metal surface and directly beneath the coating containing the at least one depot substance.

53. A method according to claim 30, wherein the metal surface is first cleaned particularly thoroughly.

54. A method according to claim 30, wherein a pretreatment layer is applied to the cleaned or clean metal surface before a coating containing depot substance is applied.

55. A method according to claim 30, wherein at least one further coating is then applied to the coating containing the depot substance.

56. A metal substrate having at least one coating prepared according to the method of claim 30.
